(19) United States
(12) Patent Application Publication
(10) Pub. No.: US 2010/0123968 A1
(43) Pub. Date: May 20, 2010

(54) METHOD OF POSITIONING ELECTROMAGNETIC CONVERSION ELEMENT

(75) Inventor: Yutaka Yoshida, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED, Kawasaki (JP)

(21) Appl. No.: 12/568,147

(22) Filed: Sep. 28, 2009

(30) Foreign Application Priority Data
Nov. 17, 2008 (JP) 2008-293010

(51) Int. Cl. G11B 21/02

(52) U.S. Cl. 360/75; G9B/21.003

(57) ABSTRACT

According to one embodiment, an electromagnetic conversion element positioning method includes: counting a servo clock for every servo sector radially extending on a recording medium, the servo clock being changed in synchronization with a change in rotation angle of the recording medium; reading magnetic information from spiral servo patterns with an electromagnetic conversion element, the spiral servo patterns being arranged at equal intervals in a circumferential direction of the recording medium, the spiral servo patterns having magnetic materials arrayed along a spiral line maintaining a defined inclined angle with respect to a circumferential line over a predetermined radial region; specifying a position of the spiral servo patterns on the circumferential line based on the read magnetic information; correlating the count value of the servo clock with the specified position; and specifying a radial position of the electromagnetic conversion element based on the correlated count value.

### CROSS-REFERENCE TO RELATED APPLICATIONS

This application is based upon and claims the benefit of priority from Japanese Patent Application No. 2008-293010, filed Nov. 17, 2008, the entire contents of which are incorporated herein by reference.

### BACKGROUND

1. Field

One embodiment of the invention relates to a recording medium drive apparatus such as a hard disk drive (HDD), particularly to a positioning method used to position an electromagnetic conversion element in the recording medium drive apparatus.

2. Description of the Related Art

A so-called spiral servo is well known in the field of the hard disk drive. In the spiral servo, a spiral servo pattern is formed on a surface of a magnetic disk. The spiral servo pattern extends along a spiral line from an innermost to an outermost of a recording region. The spiral line maintains a defined inclined angle with respect to a circumferential line in the whole area of the recording region. In the hard disk drive, the electromagnetic conversion element reads magnetic information from the spiral servo pattern with rotation of the magnetic disk. The electromagnetic conversion element is positioned in a radial direction of the magnetic disk based on the read magnetic information. The electromagnetic conversion element thus positioned writes the servo pattern in a servo sector on the magnetic disk.

The spiral servo pattern has a high-frequency region. In the high-frequency region, magnetic poles are alternately arrayed in a circumferential direction. A high-frequency reproduction signal is output when the electromagnetic conversion element traverses the high-frequency region. At the same time, synchronous marks are formed at defined intervals in the circumferential direction of the spiral servo pattern. The synchronous mark forms a gap between the high-frequency reproduction signals. The interval between the gaps corresponds to a track width. By the operation of the synchronous mark, the electromagnetic conversion element can be positioned at every recording track (for example, see U.S. Pat. Nos. 6,965,489, 6,943,978, 6,507,450, 7,113,362, 7,002,761, 7,307,806, 7,307,807, 7,139,144, 7,088,533, and 7,167,333).

In the spiral servo, the electromagnetic conversion element is positioned only based on a demodulated microscopic displacement of the electromagnetic conversion element when the electromagnetic conversion element traverses the spiral servo pattern. Accordingly, when the servo pattern writing is started in the servo sector, it is necessary to form a servo pattern (a normal servo pattern different from the spiral servo pattern, that is, an auxiliary servo pattern) in a restricted region on the magnetic disk. First the electromagnetic conversion element is positioned in the write start position based on the auxiliary servo pattern. Then the detection source of the servo information is switched from the auxiliary servo pattern to the spiral servo pattern. The electromagnetic conversion element runs on the track based on the spiral servo pattern in this manner.

In such cases, an extra process of writing the auxiliary servo pattern is necessary in operating a servo track writer (STW). In addition, because actually eccentricity is insufficiently removed between the auxiliary servo pattern and the spiral servo pattern, it is difficult to switch from the auxiliary servo pattern to the spiral servo pattern.

In the spiral servo, the interval between the synchronous marks of the spiral servo pattern has an influence on positioning accuracy of the electromagnetic conversion element read from the demodulation signal. As described above, when the interval between the synchronous marks is restricted to the track width, the interval between the synchronous marks cannot be optimized from the viewpoint of the demodulation of the signal. A demodulation noise increases. The positioning accuracy of the electromagnetic conversion element, based on the demodulation signal, is degraded.

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary plan view schematically illustrating a hard disk drive according to an embodiment of the invention;

FIG. 2 is an exemplary partially enlarged plan view schematically illustrating a surface structure of a magnetic disk in the embodiment;

FIG. 3 is an exemplary partially enlarged plan view schematically illustrating a structure of a servo sector region of in the embodiment;

FIG. 4 is an exemplary block diagram of a tracking servo control system in the embodiment;

FIG. 5 is an exemplary plan view conceptually illustrating a spiral servo pattern of a magnetic disk in the embodiment;

FIG. 6 is an exemplary partially enlarged plan view illustrating the spiral servo pattern in details and also schematically illustrating a reproduction signal based on the spiral servo pattern in the embodiment;

FIG. 7 is an exemplary block diagram of a positioning device configured in a CPU in the embodiment;

FIG. 8 is an exemplary partially enlarged plan view schematically illustrating a relationship between the spiral servo pattern and counting of a servo clock in the embodiment;

FIG. 9 is an exemplary partially enlarged plan view conceptually illustrating switching of the spiral servo pattern in the embodiment;

FIG. 10 is an exemplary flowchart of spiral servo control in the embodiment;

FIG. 11 is an exemplary flowchart of an initial operation of the spiral servo control in the embodiment; and

FIG. 12 is an exemplary partially enlarged plan view of a surface of a magnetic disk, schematically illustrating a moving pathway of an electromagnetic conversion element during the initial operation of the spiral servo control in the embodiment.

### DETAILED DESCRIPTION

Various embodiments according to the invention will be described hereinafter with reference to the accompanying drawings. In general, according to one embodiment of the invention, an electromagnetic conversion element positioning method includes: counting a servo clock for every servo sector radially extending on a recording medium, the servo clock being changed in synchronization with a change in rotation angle of the recording medium; reading magnetic information from spiral servo patterns with an electromagnetic conversion element, the spiral servo patterns being arranged at equal intervals in a circumferential direction of the recording medium, the spiral servo patterns having magnetic materials arrayed along a spiral line maintaining a defined inclined angle with respect to a circumferential line over a predetermined radial region; specifying a position of the spiral servo patterns on the circumferential line based on the read magnetic information; correlating the count value of the servo clock with the specified position; and specifying a radial position of the electromagnetic conversion element based on the correlated count value.

An embodiment of the invention will be described below with reference to the accompanying drawings.

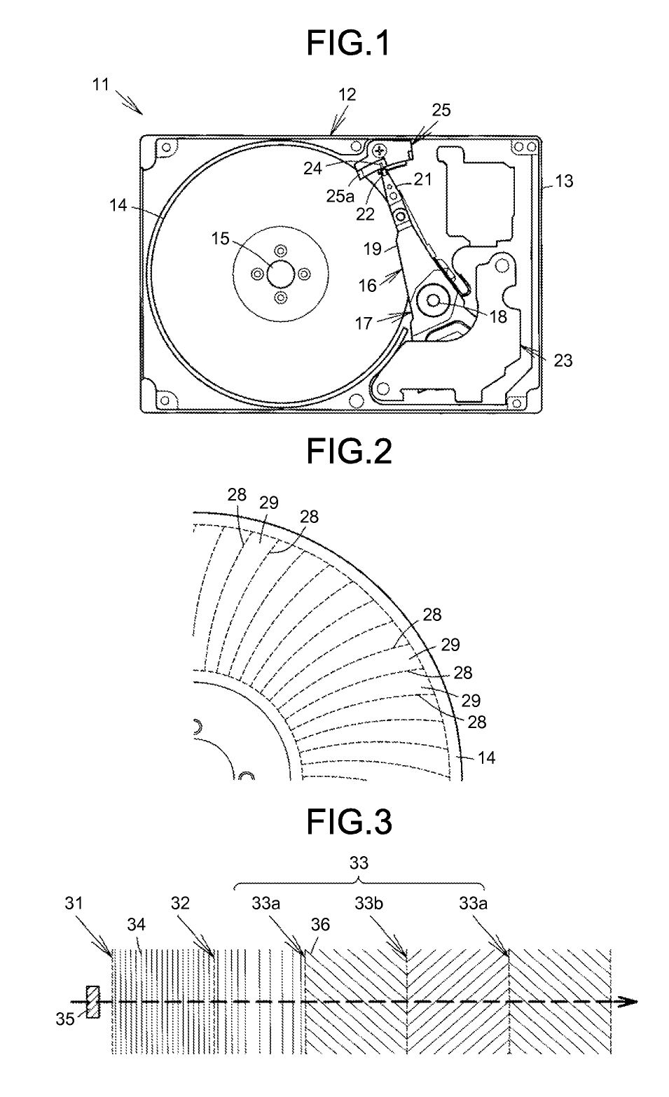

FIG. 1 schematically illustrates an internal structure of a specific example of a magnetic recording medium drive apparatus, that is a hard disk drive (HDD) 11. The HDD 11 includes a chassis, that is, a housing 12. The housing 12 includes a boxy base 13 and a cover (not illustrated). For example, the base 13 defines a flat, rectangular-solid inner space, that is, an accommodation space. The base 13 may be formed by casting a metallic material such as Aluminum. The cover is joined to an opening of the base 13. The accommodation space is sealed between the cover and the base 13. The cover may be formed from one plate material by press working.

A specific example of the magnetic recording medium, that is, at least one magnetic disk 14 is accommodated in the accommodation space. The magnetic disk 14 is mounted on a spindle shaft of a spindle motor 15. The spindle motor 15 can rotate the magnetic disk 14 at high speed such as 5400 rpm, 7200 rpm, 10000 rpm, and 15000 rpm. As described later, each magnetic disk 14 includes a so-called vertical magnetic recording medium.

A carriage 16 is also accommodated in the accommodation space. The carriage 16 includes a carriage block 17. The carriage block 17 is rotatably coupled to a support shaft 18 that is perpendicularly extended from a bottom plate of the base 13. A plurality of carriage arms 19 are provided in the carriage block 17. The carriage arms 19 are horizontally extended from the support shaft 18. For example, the carriage block 17 may be formed from Aluminum by extrusion.

A head suspension 21 is attached to a leading end of each carriage arm 19. The head suspension 21 is extended forward from the leading end of the carriage arm 19. A flexure is bonded to the head suspension 21. A floating head slider 22 is supported on the flexure. An attitude of the floating head slider 22 can be changed relative to the head suspension 21 based on the flexure. A head element, that is, an electromagnetic conversion element (not illustrated) is mounted on the floating head slider 22.

The electromagnetic conversion element includes a write head element and a read head element. A so-called magnetic monopole head is used as the write head element. The magnetic monopole head produces a magnetic field by action of a thin-film coil pattern. The main magnetic pole causes the magnetic field acts on the magnetic disk 14 in a direction perpendicular to a surface of the magnetic disk 14. Information is written in the magnetic disk 14 by the effect of the magnetic field. On the other hand, a giant magnetoresistive (GMR) element or a Tunnel junction magnetoresistive (TMR) element is used as the read head element. In the GMR element or TMR element, a resistance change of a spin valve film or a tunnel junction film is generated according to an orientation of the magnetic field acting from the magnetic disk 14. The information is read from the magnetic disk 14 based on the resistance change.

When an air current is produced on the surface of the magnetic disk 14 based on the rotation of the magnetic disk 14, a positive pressure, that is, a buoyant force and a negative pressure acts on the floating head slider 22 by the action of the air current. The buoyant force equilibrates with the negative pressure and pressing force of the head suspension 21. In rotating the magnetic disk 14, the floating head slider 22 can continuously be floated with relatively high rigidity based on the equilibrium.

A voice coil motor (VCM) 23 is coupled to the carriage block 17. The carriage block 17 can be rotated about the support shaft 18 by the operation of the VCM 23. The carriage arm 19 and the head suspension 21 are oscillated based on the rotation of the carriage block 17. When the carriage arm 19 is oscillated about the support shaft 18 while the floating head slider 22 is floated, the floating head slider 22 can be moved along a radial line of the magnetic disk 14. As a result, the electromagnetic conversion element on the floating head slider 22 can traverse a coaxial recording track between an innermost recording track and an outermost recording track. The electromagnetic conversion element is positioned relative to the target recording track based on the movement of the floating head slider 22.

A load tub 24 extending forward from the leading end of the head suspension 21 is provided at the leading end of the head suspension 21. The load tub 24 can be moved in the radial direction of the magnetic disk 14 based on the oscillation of the carriage arm 19. On the moving pathway of the load tub 24, a ramp member 25 is disposed outside the magnetic disk 14. The ramp member 25 is fixed to the base 13. The load tub 24 is received by the ramp member 25. For example, the ramp member 25 may be formed by molding a hard plastic material.

A ramp 25a extending along the moving pathway of the load tub 24 is formed in the ramp member 25. The ramp 25a is moved away from a virtual plane including the surface of the magnetic disk 14 as the distance from the rotating axis of the magnetic disk 14 is increased. Accordingly, when the carriage arm 19 is moved away from the rotating axis of the magnetic disk 14 about the support shaft 18, the load tub 24 climbs the ramp 25a, whereby the floating head slider 22 is separated from the surface of the magnetic disk 14. The floating head slider 22 is retracted to the outside from the magnetic disk 14. On the contrary, when the carriage arm 19 is oscillated toward the rotating axis of the magnetic disk 14 about the support shaft 18, the load tub 24 goes down the ramp 25a. The buoyant force acts on the floating head slider 22 from the rotating magnetic disk 14. The ramp member 25 and the load tub 24 constitute a so-called load/unload mechanism.

As illustrated in FIG. 2, a plurality of (for example, 200) servo sector regions 28 extending in a curved state along the radial direction of the magnetic disk 14 are defined on the surface and backside of the magnetic disk 14. The servo sector regions 28 are arranged in a circumferential direction at equal intervals. A servo pattern is formed in the servo sector region 28. The electromagnetic conversion element on the floating head slider 22 reads the magnetic information written in the servo pattern. The floating head slider 22 is positioned in the radial direction of the magnetic disk 14 based on the information read from the servo pattern. One circular recording track is formed according to the positioning. The recording track is concentrically formed based on the radial displacement of the floating head slider 22. The curvature of the servo sector region 28 is set based on the moving pathway of the electromagnetic conversion element.

A data region 29 is ensured between the adjacent servo sector regions 28. The electromagnetic conversion element traces a recording track in the data region 29 according to the positioning based on the servo pattern. The write head element of the electromagnetic conversion element writes magnetic information along the recording track. The read head element of the electromagnetic conversion element reads the magnetic information along the recording track.

FIG. 3 illustrates the servo sector region 28 of a specific example. In each servo sector region 28, a preamble region 31, a servo mark address region 32, and a phase burst region 33 are defined in this order from the upstream side. For example, a plurality of magnetization patterns 34 extending on a radius line of the magnetic disk 14 are formed in the preamble region 31. The magnetization patterns 34 are arranged at equal intervals in the circumferential direction of the magnetic disk 14. Therefore, the synchronization of the signal read from a read element 35 is ensured by the operation of the preamble region 31. At the same time, a gain is adjusted based on the signal read from the read element 35. The “upstream” and “downstream” are defined based on the traveling direction of the floating head slider 22 during the rotation of the magnetic disk 14.

Magnetic poles, that is, an N pole and an S pole are arranged in a specific pattern in the servo mark address region 32. The arrangement of the magnetic poles reflects a sector number and a track number. At the same time, a plurality of magnetization patterns extending on the radius line of the magnetic disk 14 are formed in the servo mark address region 32. The magnetization pattern specifies a servo clock signal. A phase, which is described later, is specified based on the servo clock signal. The sector number and the track number are specified by the operation of the servo mark address region 32. At the same time, reference timing of the phase is specified by the operations of the preamble region 31 and the servo mark address region 32.

A plurality of magnetization patterns, that is, phase burst lines 36 extending with a predetermined inclined angle relative to the radius line of the magnetic disk 14 are formed in the phase burst region 33. In forming the phase burst lines 36, even regions 33a and odd regions 33b are alternately arranged in a phase burst region 38. The even region 33a and the odd region 33b are used in pairs. In the even region 33a, the phase is delayed as the read element 35 passing through the phase burst lines 36 is deviated toward the inner circumferential side of the magnetic disk 14. On the other hand, in the odd region 33b, the phase is gained as the read element 35 passing through the phase burst lines 36 is deviated toward the outer circumferential side of the magnetic disk 14.

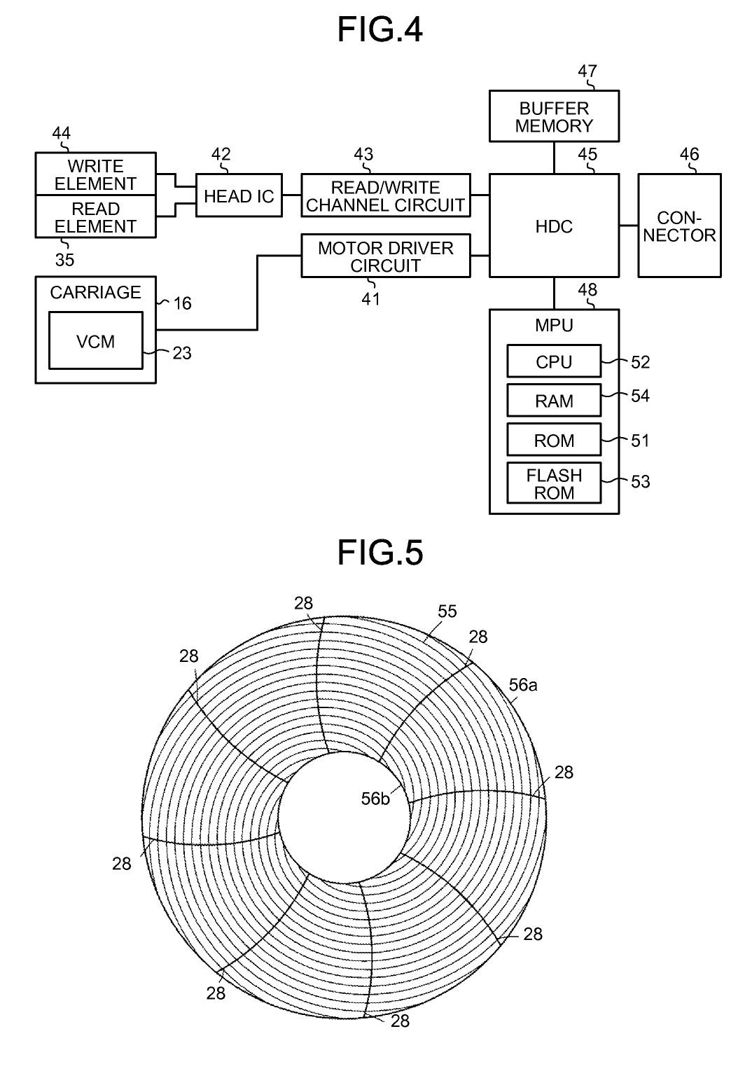

As illustrated in FIG. 4, a motor driver circuit 41 is connected to the VCM 23. The motor driver circuit 41 supplies a drive current to the VCM 23. The VCM 23 is displaced by a specified displacement amount based on the supplied drive current. The displacement amount is set according to a rotation amount (rotation angle) of the carriage block 17.

A read/write channel circuit 43 is connected to a head IC 42. The read/write channel circuit 43 modulates and demodulates the signal according to a determined modulation/demodulation system. The modulated signal, that is, a write signal is supplied to the head IC 42. The head IC 42 amplifies the write signal. The amplified write signal is supplied to a write element 44. The read signal supplied from the read element 35 is amplified by the head IC 42, and then supplied to the read/write channel circuit 43. The read/write channel circuit 43 demodulates the read signal.

A hard disk controller (HDC) 45 is connected to the motor driver circuit 41 and the read/write channel circuit 43. The HDC 45 supplies a control signal to the motor driver circuit 41. An output of the motor driver circuit 41, that is, the drive current is controlled based on the control signal. The HDC 45 feeds the write signal to the read/write channel circuit 43 before the modulation, and the HDC 45 receives the read signal from the read/write channel circuit 43 after the demodulation. Before the modulation, the HDC 45 may produce the write signal based on data delivered from, for example, a host computer. The data may be transferred from a connector 46 to the HDC 45. A control signal cable (not illustrated) or a power cable (not illustrated), which extend from a main board of the host computer, may be connected to the connector 46. Similarly the HDC 45 reproduces the data based on the read signal after the demodulation. The reproduced data may be supplied from the connector 46 to the host computer. In transmitting and receiving the data, for example, the HDC 45 can utilize a buffer memory 47. The data is temporarily stored in the buffer memory 47. For example, a synchronous dynamic random access memory (SDRAM) may be used as the buffer memory 47.

A micro processor unit (MPU) 48 is connected to the HDC 45. The MPU 48 includes a central processing unit (CPU) 52 that is operated based on a program stored in, for example, a read only memory (ROM) 51. The program includes an electromagnetic conversion element positioning program. The electromagnetic conversion element positioning program may be provided in the form of firmware. The CPU 52 can obtain the data from, for example, a flash ROM 53 when implementing its operation. The program and the data can temporarily be stored in a random access memory (RAM) 54. The ROM 51, the flash ROM 53, and the RAM 54 may directly be connected to the CPU 52.

In the tracking servo control, the read element 35 outputs a signal when the read element 35 passes through the preamble region 31, the servo mark address region 32, and the phase burst region 33 in this order. The HDC 45 produces a servo clock signal based on the passage of the read element 35 through the servo mark address region 32. Then, the HDC 45 captures a signal waveform for every even region and every odd region based on the passage of the read element 35 through the phase burst region 33. The HDC 45 averages the signal waveforms by fast Fourier transform. The HDC 45 computes a phase difference for every even region and every odd region based on the servo clock signal and the signal waveform. The HDC 45 outputs a position error signal based on the computed phase difference. The position error signal is supplied as the control signal to the VCM 23. As a result, the electromagnetic conversion element can trace the target recording track.

It is assumed that the servo sector region 28 is now formed in the magnetic disk 14. First, the spiral servo pattern is written in the new magnetic disk 14. A servo track writer (STW) is used to write the spiral servo pattern. The magnetic disk 14 is mounted on the STW. The STW rotates the magnetic disk 14 at a constant rotating speed. At the same time, the STW radially moves the write element at a constant moving speed. For example, the write element may be mounted on the predetermined floating head slider. For example, the floating head slider may be moved on the radius line of the magnetic disk 14. The magnetic field acts on the magnetic disk 14 from the write element.

As illustrated in FIG. 5, a spiral servo patterns 55 are arranged at equal intervals in the circumferential direction. The number of the spiral servo patterns 55 is set double the number of the servo sector regions 28. That is, two spiral servo patterns 55 are allocated to one servo sector region 28. Alternatively, three or more spiral servo patterns may be allocated to one servo sector region 28. Also in such cases, the spiral servo patterns may be arranged at equal intervals in the circumferential direction. In FIG. 5, for convenience, the servo sector region 28 and the spiral servo pattern 55 are illustrated in a simplified manner.

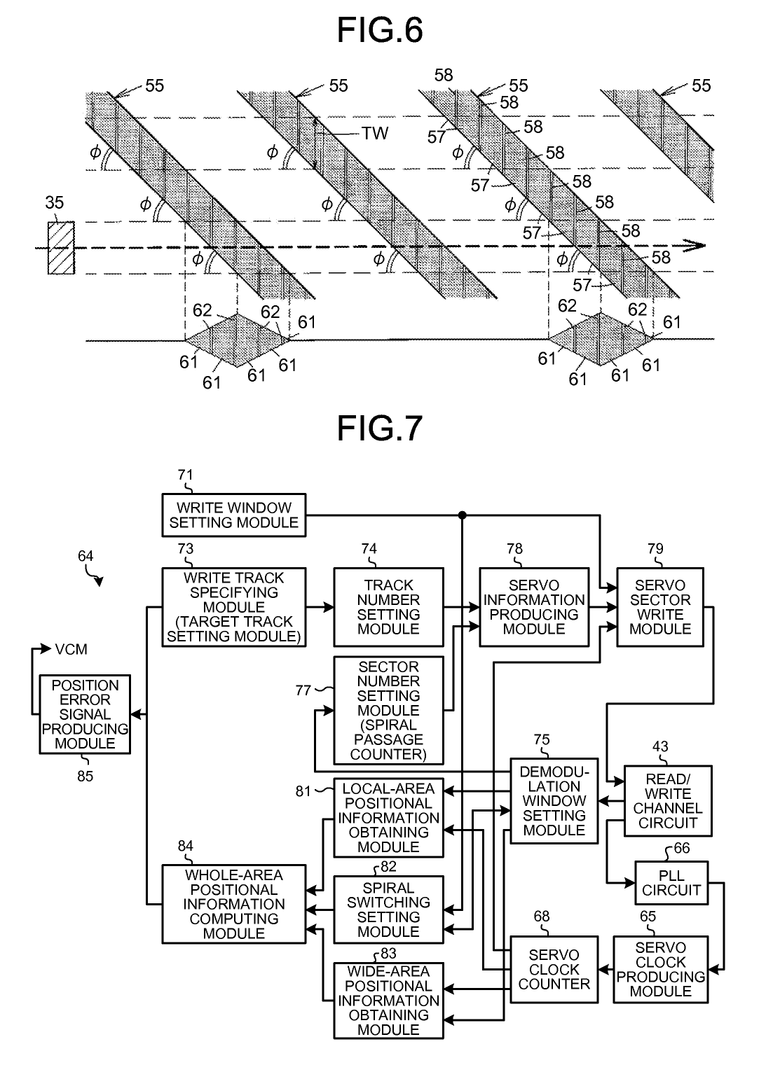

Each spiral servo pattern 55 extends along a spiral line from an outermost track 56a to an innermost track 56b of the recording region. The recording region corresponds to a maximum range where the magnetic information can be written with the write element 44. As illustrated in FIG. 6, the spiral line maintains a defined inclined angle φ with respect to the circumferential line in the whole area of the recording region.

In each spiral servo pattern 55, magnetization regions are arrayed along the spiral line. The N poles and the S poles are alternately arranged in the circumferential direction. A high-frequency region 57 is formed based on the arrangement. A radial length of the magnetization region is set to a recording track width TW. The radial length is measured on the radius line of the magnetic disk 14. In forming the high-frequency region 57, the high-frequency write signal is supplied to the write element 44 according to the predetermined write clock.

Synchronous marks 58 are formed at defined intervals in the circumferential direction of the spiral servo pattern 55. For example, the synchronous mark 58 includes a magnetic monopole. In forming the synchronous mark 58, a write signal having a constant value is supplied to the write element 44. The write signal having the constant value is maintained over a defined number of clock pulses of the write clock. Therefore, the high frequency is interrupted.

When the read element 35 traverses the high-frequency region 57, the read element 35 outputs a high-frequency reproduction signal 61. Amplitude of the reproduction signal 61 is gradually increased. When the read element 35 lies down on the spiral servo pattern 55 with a track width TW, the reproduction signal 61 exerts the maximum amplitude. Then, the amplitude of the reproduction signal 61 is gradually decreased. The synchronous mark 58 causes a gap 62 between the high-frequency reproduction signals 61. The high-frequency reproduction signals 61 are separated from each other by the gap 62. An interval between the synchronous marks 58 is arbitrarily set. However, when the position of the gap 62 is optimized on the reproduction signals of the read element 35, the disturbance, that is, the noise can be suppressed to the minimum in the reproduction signal, that is, the high-frequency reproduction signal 61. For the intervals between the synchronous marks 58, it is not always necessary to specify a track pitch. The synchronous marks 58 are arranged at equal intervals in the circumferential direction. The read element 35 passes through at least two synchronous marks 58 when the read element 35 traverses one spiral servo pattern 55.

When the writing of the spiral servo pattern 55 is completed, the magnetic disk 14 is dropped from the STW. Then, the magnetic disk 14 is incorporated in the hard disk drive 11. Subsequently, the magnetization is written in the servo sector region 28 for every hard disk drive 11 based on the written spiral servo pattern 55. In writing the spiral servo pattern 55, the CPU 52 executes the electromagnetic conversion element positioning program. At this point, the CPU 52 acts as an electromagnetic conversion element positioning device based on the execution of the positioning program.

FIG. 7 is a block diagram of a positioning device 64 constructed in the CPU 52. The positioning device 64 includes a servo clock producing module 65. The servo clock producing module 65 produces the servo clock. The servo clock generates pulses in synchronization with the rotation of the magnetic disk 14, that is, the change in rotation angle. In generating the pulses, for example, a phase lock loop (PLL) circuit 66 may be connected to the servo clock producing module 65. The read/write channel circuit 43 is connected to the PLL circuit 66. The read/write channel circuit 43 supplies phase information to the PLL circuit 66 based on a demodulation signal of the spiral servo pattern 55.

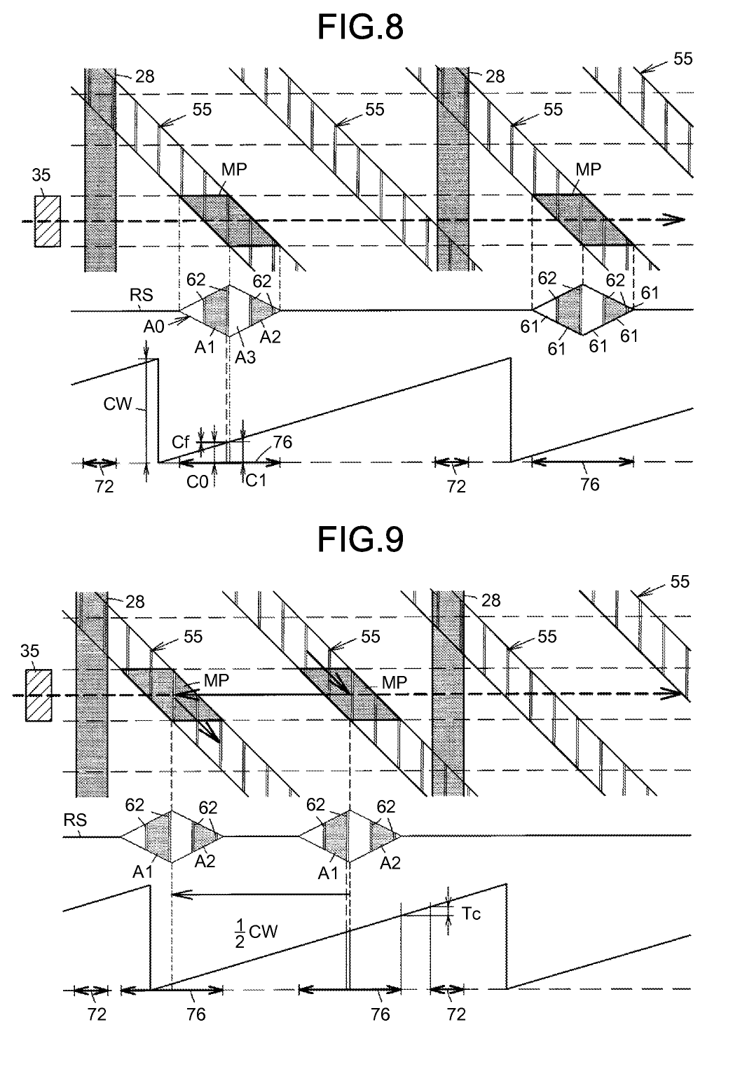

A servo clock counter 68 counts the servo clock. The servo clock counter 68 specifies a count value of the servo clock. As illustrated in FIG. 8, the count value is reset when the count value reaches a predetermined value CW. After resetting the count value, the servo clock counter 68 starts the counting again. The predetermined value CW specifies the interval between the adjacent servo sector regions 28. That is, one servo sector region 28 is allocated for one resetting, that is, for the turn-back of the counting.

For example, a write window setting module 71 sets a write window 72 based on the count value of the servo clock. As illustrated in FIG. 8, the write window 72 specifies a time frame having a predetermined length of time. The write element 44 can perform the write operation within the time frame. The write element 44 is prohibited to perform the write operation out of the time frame of the write window 72. The write window 72 emerges in a predetermined period. A count value equal to or lower than the predetermined value CW is used to set the period.

A write track specifying module 73 specifies one recording track based on the count value of the servo clock. A physical track is formed when the magnetization of the preamble region 31, the magnetization of the servo mark address region 32, and the magnetization of the phase burst region 33 are written in the servo sector region 28 based on the specified count value. For example, when the recording tracks are sequentially formed toward the outside in the radial direction of the magnetic disk 14, the write track specifying module 73 adds the number of clocks Tp (hereinafter referred to as “the number of clocks corresponding to track pitch”) corresponding to one track pitch to the current count value to specify a new recording track. On the other hand, when the recording tracks are sequentially formed toward the inside in the radial direction of the magnetic disk 14, the write track specifying module 73 subtracts the number of clocks corresponding to track pitch Tp from the current count value to specify a new recording track. In both the cases, any count value, that is, an initial value Cs may be allocated to the innermost (or outermost) recording track. The maximum count value is derived by adding a product of a numeric value obtained by subtracting “1” from the number of recording tracks and the number of clocks corresponding to track pitch Tp to the initial value Cs. As described later, the write track specifying module 73 also acts as a target track setting module.

A track number setting module 74 sets the track number. In setting the track number, the write track specifying module 73 supplies a count value R to the track number setting module 74. After the initial value Cs is subtracted from the count value R, the subtraction result is divided by the number of clocks corresponding to track pitch Tp, thereby specifying a track number Pt.

$$Pt = \frac{( R - Cs )}{Tp} \qquad ( 1 )$$

A demodulation window setting module 75 sets a demodulation window based on the demodulation signal of the spiral servo pattern 55. As illustrated in FIG. 8, for example, a demodulation window 76 specifies the time frame corresponding to the demodulation signal of the spiral servo pattern 55. For example, the time length of the demodulation window 76 is set equal to the time length of the demodulation signal. The demodulation window 76 is fixed to the demodulation signal of the spiral servo pattern 55. Accordingly, the demodulation window 76 emerges every time the demodulation signal of the spiral servo pattern 55 is detected. The demodulation signal is taken out based on the demodulation window 76. The demodulation signal is supplied from the read/write channel circuit 43. The read element 35 supplies the read signal to the read/write channel circuit 43.

A sector number setting module 77 is connected to the demodulation window setting module 75. The sector number setting module 77 specifies the sector number based on the number of passages of the spiral servo pattern 55. The number of passages is recognized based on the number of emergences of the demodulation window 76. The number of emergences is counted. The initial value of the sector number may be set to “0 (zero)”. The initial value of the sector number is allocated to any demodulation window 76 in one rotation of the magnetic disk 14. The maximum value of the sector number is set based on the number of servo sector regions 28. When the initial value is set to “0”, the maximum value of the sector number is set to a numeric value obtained by subtracting “1” from the number of the servo sector regions 28. As described later, the sector number setting module 77 also acts as a spiral passage counter. However, as described later, the sector number is corrected in switching the spiral servo pattern 55.

A servo information producing module 78 is connected to the track number setting module 74 and the sector number setting module 77. The track number setting module 74 notifies the servo information producing module 78 of the track number. Similarly, the sector number setting module 77 notifies the servo information producing module 78 of the sector number. The servo information producing module 78 produces servo information based on the track number and the sector number.

A servo sector write module 79 is connected to the servo information producing module 78. The servo information producing module 78 notifies the servo sector write module 79 of the servo information. The servo sector write module 79 sets the magnetization of the preamble region 31, the magnetization of the servo mark address region 32, and the magnetization of the phase burst region 33 based on the servo information. At the same time, the write window setting module 71 and the servo clock counter 68 are connected to the servo sector write module 79. The set magnetization is supplied to the read/write channel circuit 43 in predetermined timing. In setting the timing, the write window setting module 71 notifies the servo sector write module 79 of the count value of the write window 72. The count value of the write window 72 is correlated with the counting of the servo clock. Thus, the read/write channel circuit 43 outputs the write signal. A write current of the write element 44 is produced based on the write signal. The write element 44 constructs the servo sector region 28.

A local-area positional information obtaining module 81 is connected to the demodulation window setting module 75. At the same time, the servo clock counter 68 is connected to the local-area positional information obtaining module 81. The local-area positional information obtaining module 81 specifies the position of the electromagnetic conversion element in the radial direction of the magnetic disk 14 based on a count value C1 of the servo clock. The count value C1 specifies the position of the electromagnetic conversion element in the radial direction of the magnetic disk 14. In specifying the position of the electromagnetic conversion element, the position of the spiral servo pattern 55 is specified in the circumferential direction of the magnetic disk 14. In specifying the circumferential position, the servo clock counter 68 supplies the count value of the servo clock to the local-area positional information obtaining module 81. The local-area positional information obtaining module 81 specifies the count value C1 of the servo clock based on the demodulation signal of the spiral servo pattern 55.

As illustrated in FIG. 8, when the read element 35 traverses the spiral servo pattern 55, the amplitude of the reproduction signal RS forms a “rhomboid” along a temporal axis. In the rhomboid, one diagonal orthogonal to the temporal axis corresponds to the maximum amplitude. The diagonal corresponds to an intermediate position of a moving pathway MP of the read element 35 formed on the spiral servo pattern 55. A change in amplitude over time forms a symmetric shape based on the diagonal. Accordingly, a relative position Cf of the diagonal with respect to the gap 62 can be specified by comparing an area A1 of a reproduction signal RS specified between the pair of gaps 62 in the former half region of the temporal axis and an area A2 of the reproduction signal RS specified between the pair of gaps 62 in the latter half region of the temporal axis. The areas A1 and A2 of the reproduction signal RS may be computed with, for example, an integrator. Alternatively, the relative position Cf can be specified based on a whole area A0 of the “rhomboid” of the reproduction signal RS and an area A3 in an intermediate region of the temporal axis. The intermediate region corresponds to a region that includes the diagonal and is sandwiched between the pair of gaps 62, that is, a region sandwiched between the areas A1 and A2. The position of the gap 62 is correlated with the counting of the servo clock. That is, the position of the gap 62 can be specified by the count value C0 of the servo clock.

C1=C0+Cf (2)

Therefore, in each turn-back of the counting, the maximum amplitude position of the reproduction signal RS can be specified based on the count value C1 of the servo clock. The position of the spiral servo pattern 55 is specified on the moving pathway of the read element 35.

As illustrated in FIG. 7, a spiral switching setting module 82 is connected to the demodulation window setting module 75. At the same time, the write window setting module 71 is connected to the spiral switching setting module 82. The spiral switching setting module 82 compares the demodulation window 76 and the write window 72. For example, when the interval between the demodulation window 76 and the write window 72 is lower than the predetermined number of clocks, the spiral switching setting module 82 determines the switching of the spiral servo pattern 55 as described later. The spiral switching setting module 82 instructs the demodulation window setting module 75 to switch the spiral servo patterns 55. As illustrated in FIG. 9, the demodulation window setting module 75 moves the demodulation window 76 along the circumferential direction from the spiral servo pattern 55 of the current demodulation target to the preceding or subsequent spiral servo pattern 55. The spiral switching setting module 82 produces a correction value C2 of the counting according to the switching of the spiral servo pattern 55. The correction value C2 is determined based on the number of spiral servo patterns 55 allocated to one servo sector region 28 and a predetermined value CW. For example, as illustrated in FIG. 9, the correction value C2 is set based on the following equation, when the spiral servo pattern 55 is set after switching in the rotating direction of the magnetic disk 14.

$$C 2 = C 2 - \frac{1}{2} C W \qquad ( 3 )$$

On the other hand, the correction value C2 is set based on the following equation, when the spiral servo pattern 55 is set after switching in the opposite direction to the rotating direction of the magnetic disk 14.

$$C 2 = C 2 + \frac{1}{2} C W \qquad ( 4 )$$

The initial value of the correction value C2 is set to “0”.

As illustrated in FIG. 7, a wide-area positional information obtaining module 83 is connected to the demodulation window setting module 75. At the same time, the servo clock counter 68 is connected to the wide-area positional information obtaining module 83. The wide-area positional information obtaining module 83 specifies the position of the electromagnetic conversion element in the radial direction of the magnetic disk 14 based on a count value C3 of the servo clock. The count value C3 specifies the local area position in the radial direction of the magnetic disk 14 between the outermost track 56a and the innermost track 56b of the recording region. In specifying the local area position, the number of turned-back times Ns is counted during the counting of the servo clock. For example, when a decrease equal to or more than a defined value is detected in the count value of the servo clock during moving the electromagnetic conversion element, the number of turned-back times Ns is specified from the following equation.

Ns=Ns+1 (5)

On the other hand, when an increase equal to or more than the defined value is detected in the count value of the servo clock during moving the electromagnetic conversion element, the number of turned-back times Ns is specified from the following equation.

Ns=Ns−1 (6)

The count value C3 is specified from the following equation based on the number of turned-back times Ns and the predetermined value CW of the servo clock, that is, the maximum count value.

C3=Ns×CW (7)

The initial value of the number of turned-back times Ns is set to “0 (zero)”.

A whole-area positional information computing module 84 is connected to the local-area positional information obtaining module 81, the spiral switching setting module 82, and the wide-area positional information obtaining module 83. The whole-area positional information computing module 84 specifies the position of the electromagnetic conversion element in the radial direction of the magnetic disk 14 based on the count value C1, the correction value C2, and the count value C3. The total number of clocks Ct of the count value C1, correction value C2, and count value C3 are computed.

Ct=C1+C2+C3 (8)

The count value C1, the correction value C2, and the count value C3 are simply added in the computation. The total number of clocks Ct specifies the position of the electromagnetic conversion element in the radial direction of the magnetic disk 14 between the outermost track 56a and the innermost track 56b of the recording region.

A position error signal producing module 85 is connected to the whole-area positional information computing module 84. At the same time, the write track specifying module 73 is connected to the position error signal producing module 85. The position error signal producing module 85 checks the total number of clocks Ct from the whole-area positional information computing module 84 with the count value R specified by the write track specifying module 73. A difference between the count value and the total number of clocks Ct is computed. The difference corresponds to a position error signal PES. The position error signal PES is supplied to the VCM 23. The drive current of the VCM 23 is set according to the position error signal PES. As a result, the electromagnetic conversion element can be positioned on any recording track based on the spiral servo pattern 55.

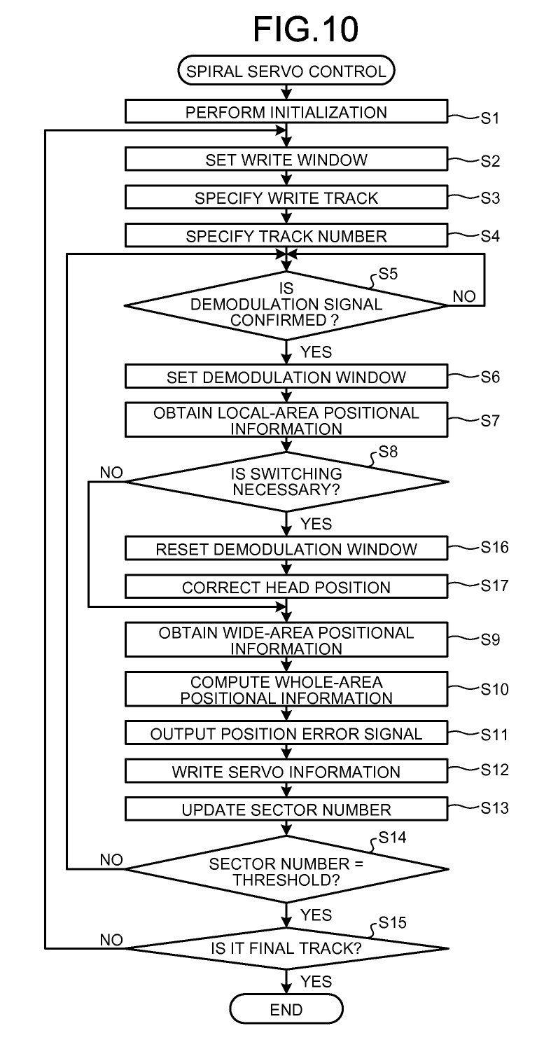

A processing operation of the spiral servo control implemented by the CPU 52 based on the execution of the positioning program will be described below. As illustrated in FIG. 10, initialization is performed in S1. The rotation of the magnetic disk 14 is started. The magnetic disk 14 is maintained at a constant rotating speed. The servo clock is counted. The servo clock is changed in synchronization with the change in rotation angle of the magnetic disk 14. The clock pulse is generated. The servo clock is counted. The function of the servo clock counter 68 is implemented in counting the servo clock. At the same time, a predetermined variable is initialized.

Subsequently in S2, the write window 72 is set. The function of the write window setting module 71 is realized in setting the write window 72. In S3, the write track is specified. The method of specifying the first write track is described later. For example, the initial value “Cs” of the count value is set to the innermost recording track. In S4, the track number Pt is specified. The function of the track number setting module 74 is realized in setting the track number Pt. At this point, the count value R is set to the initial value “Cs”. In S5, the CPU 52 confirms whether the demodulation signal of the spiral servo pattern 55 exists.

When the demodulation is confirmed in S5, the demodulation window 76 is set in S6. The function of the demodulation window setting module 75 is realized in setting the demodulation window 76. The CPU 52 captures the demodulation signal of the spiral servo pattern 55. In S7, the CPU 52 obtains the local-area positional information based on the demodulation signal. The function of the local-area positional information obtaining module 81 is realized in obtaining the local-area positional information. As a result, the count value C1 is specified as illustrated in FIG. 8, for example. The position of the spiral servo pattern 55 is specified on one circumferential line.

In S8, necessity for the switching of the spiral servo pattern 55 is determined. The function of the spiral switching setting module 82 is realized in the determination. The correction value C2 is maintained at the previous value when an interval Tc between the demodulation window 76 and the write window 72 is ensured to be not lower than the predetermined number of clocks. The processing operation of the CPU 52 goes to S9. In S9, the wide-area positional information is obtained based on the demodulation signal. The function of the wide-area positional information obtaining module 83 is realized in obtaining the wide-area positional information.

In S10, the CPU 52 computes the whole-area positional information. The function of the whole-area positional information computing module 84 is implemented in the computation. The total number of clocks Ct is computed. Thus, the count value of the servo clock is correlated with the demodulation signal of the spiral servo pattern 55. The total number of clocks Ct specifies the position of the electromagnetic conversion element in the radial direction of the magnetic disk 14.

Subsequently in S11, the CPU 52 produces the position error signal PES. The function of the position error signal producing module 85 is implemented in producing the position error signal PES. The position error signal PES is supplied to the voice coil motor 23. The electromagnetic conversion element is positioned on a predetermined circular recording track based on the position error signal PES. When the electromagnetic conversion element is positioned, the servo information is written in the magnetic disk 14 in S12. The function of the servo sector write module 79 is implemented in writing the servo information. The servo sector region 28 is constructed. The function of the servo information producing module 78 is implemented in producing the servo information. The track number and the sector number are specified in the servo information. The function of the track number setting module 74 is implemented in specifying the track number (equation 1). The function of the sector number setting module 77 is implemented in specifying the sector number. At this point, the sector number is determined based on the number of passages H of the spiral servo pattern 55. However, the sector number is corrected in switching the spiral servo pattern 55 when the post-switching spiral servo pattern 55 is set in the opposite direction to the rotating direction of the magnetic disk 14. That is, when the electromagnetic conversion element passes through the spiral servo pattern 55 immediately after the post-switching spiral servo pattern 55 is set in the opposite direction to the rotating direction of the magnetic disk 14, the sector number is determined by the following equation.

Ps=Ps+2 (9)

When the electromagnetic conversion element passes through the spiral servo pattern 55 in other situations, the sector number is determined by the following equation.

Ps=Ps+1 (10)

However, the sector number is determined by the following equation until the first write track is specified in S3.

Ps=H (11)

When the servo pattern is written in one servo sector region 28, the sector number is updated in subsequent S13.

In S14, the sector number is compared to a threshold. The threshold specifies one rotation of the magnetic disk 14. The processing operation of the CPU 52 returns to S5 when the sector number is lower than the threshold. When the demodulation is confirmed in S5, the processing in S6 to S13 is performed again. One circular recording track is formed on the magnetic disk 14 when writing of the servo patterns in all the servo sector regions 28 according to the rotation of the magnetic disk 14 is completed. The processing operation of the CPU 52 goes to S15. A determination whether the formed circular recording track is the final track is made in S15. The processing operation of the CPU 52 returns to S3 when the circular recording track is not the final track. In S3, the number of clocks corresponding to track pitch Tp is added to the initial value “Cs” of the count value. The circular recording track is specified one by one toward the outside from the first circular recording track every time the number of clocks corresponding to track pitch Tp is added. In S4, the track number Pt is updated. Then, the position error signal PES is produced in S11 as described above. The electromagnetic conversion element is positioned on the specified circular recording track. As a result of the repetition of the processing in S5 to S14, another circular recording track is formed on the magnetic disk 14.

As illustrated in FIG. 9, when the interval Tc between the demodulation window 76 and the write window 72 is lower than the predetermined number of clocks, the CPU 52 resets the demodulation window 76 in S16. The timing of the demodulation window 76 is put ahead. The demodulation window 76 is moved forward (toward upstream side in the moving direction of the electromagnetic conversion element) from the spiral servo pattern 55 of the current demodulation target. Thus, the spiral servo patterns 55 are switched. For example, the correction value C2 is computed from Equation 3 described above according to the switching of the spiral servo pattern 55. The correction value C2 is updated every time the spiral servo patterns 55 are switched.

In S9, the number of turned-back times Ns is updated every time the decrease not less than the defined value of the count value of the servo clock is detected. The predetermined value CW of the servo clock is multiplied by the updated number of turned-back times Ns. Thus, the count value C3 is computed. According to the count value C3, the position of the electromagnetic conversion element can be expressed by the count value of the servo clock throughout the regions in the radial direction of the magnetic disk 14 although the counting of the servo clock is turned back at the predetermined value CW.

When the circular recording track formed in S15 is the final track, the processing operation of the CPU 52 is ended. Thus, the servo patterns of the circular recording track are written throughout the regions of the magnetic disk 14. According to the positioning processing operation as described above, each circular recording track can correctly be specified using the total number of clocks Ct of the servo clock.

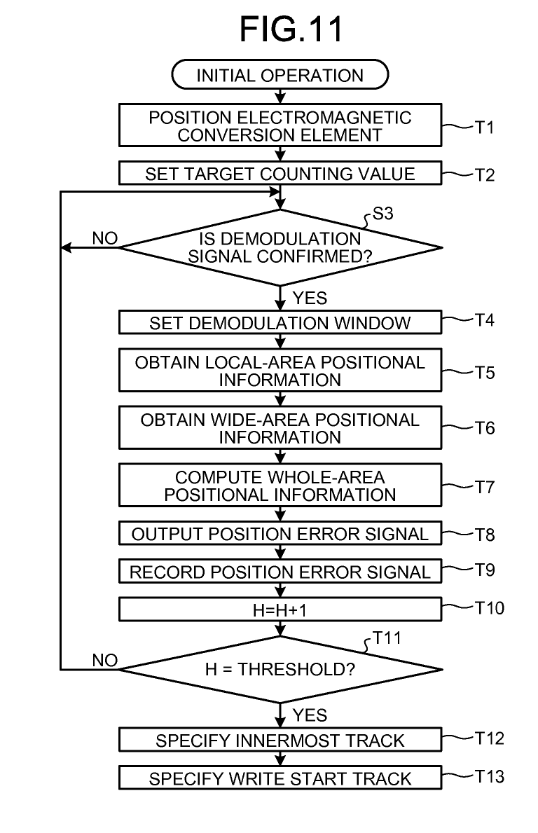

An initial operation of the spiral servo control will be described below. The first write track is specified in S3 based on the initial operation. As illustrated in FIG. 11, the electromagnetic conversion element is positioned on the innermost track 56b of the recording region in T1. At this point, for example, the carriage arm 19 is maximally driven toward the spindle shaft of the spindle motor 15. The drive current is supplied to the VCM 23. The carriage 16 is rotated about the support shaft 18. The carriage 16 abuts on a stopper (not illustrated).

In T2, the target count value R is set to a provisional value. The provisional value may be any numeric value. Alternatively, the count value R may be set after the first spiral servo pattern 55 is demodulated. At the same time, the number of turned-back times Ns and the correction value C2 are set to zero as initial values. In T3, the CPU 52 confirms whether the demodulation signal of the spiral servo pattern 55 exists.

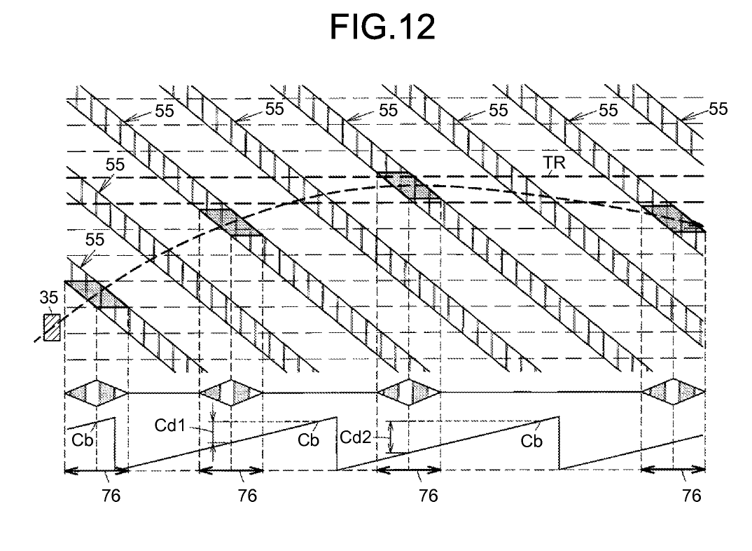

When the demodulation is confirmed in T3, the demodulation window 76 is set in T4. As with the processing in S6, the function of the demodulation window setting module 75 is implemented in setting the demodulation window 76. The CPU 52 captures the demodulation signal of the spiral servo pattern 55. In T5, the CPU 52 obtains the local-area positional information based on the demodulation signal. As with the processing in S7, the function of the local-area positional information obtaining module 81 is implemented in obtaining the local-area positional information. As a result, a count value Cb is specified as illustrated in FIG. 12, for example. The count value Cb is applied to the count value R. Subsequently in T6, the wide-area positional information is obtained. As with the processing in S9, the function of the wide-area positional information obtaining module 83 is implemented in obtaining the wide-area positional information. The count value C3 is computed. Subsequently in T7, the whole-area positional information is computed. As with the processing in S10, the function of the whole-area positional information computing module 84 is implemented in the computation. Subsequently in T8, the position error signal PES is produced. As with the processing in S11, the function of the position error signal producing module 85 is implemented in producing the position error signal PES. Subsequently in T9, the position error signal PES is recorded. The processing in S5 to S11 can directly be used in performing the processing in T3 to T9.

In T10, the number of passages H of the spiral servo pattern is counted. The initial value of the number of passages H is set to “0 (zero)” in advance. In T11, the number of passages H is compared to a threshold. The threshold may be set to any numeric value (natural number). For example, the number of passages of a plurality of rotations of the magnetic disk 14 may be set to the threshold. The processing operation of the CPU 52 returns to T3 when the number of passages H does not reach the threshold. Then the processing in T3 to T9 is performed. When the number of passages H reaches the threshold in T11, the processing operation of the CPU 52 goes to T12. In T12, the innermost track is specified. The position error signals of several rotations, recorded in T9, are referred to in specifying the innermost track. As illustrated in FIG. 12, errors Cd1, Cd2, . . . are specified between the target count value R (=Cb) and the total number of clocks Ct every time the electromagnetic conversion element passes through the spiral servo pattern 55. The position of the electromagnetic conversion element can correctly be correlated with the count value of the servo clock within the radial moving range of the electromagnetic conversion element based on the errors Cd1, Cd2, . . . . As a result, as illustrated in FIG. 12, a count value Ci of an innermost circular recording track TR can be specified by the following equation.

Ci=Cb−Cd2 (12)

In the initial operation, irrespective of the periodic displacement of the electromagnetic conversion element due to the eccentricity, the position of the electromagnetic conversion element can correctly be specified in the radial direction. When the innermost circular recording track is specified, the write start track is specified in T13. The innermost circular recording track may be applied to the write start track. That is, the count value Ci is applied to the count value of the write start track.

In the spiral servo control as described above, not only the microscopic displacement of the electromagnetic conversion element can accurately be specified based on the “rhombic” reproduction signal RS, but also the position of the electromagnetic conversion element can accurately be specified throughout the movable range of the carriage arm 19. Accordingly, like the initial operation, the electromagnetic conversion element can directly be positioned on the spiral servo pattern 55 from the state in which the carriage 16 abuts on the stopper. As a result, the write of the so-called auxiliary servo pattern can be neglected. The processing operation of the STW can be simplified in constructing the servo sector region 28. The simplification contributes to the shortened work time and the reduction of the production cost.

As described above, according to the embodiment, the position of the spiral servo pattern can be specified on a moving pathway of the electromagnetic conversion element based on the counting of the servo clock. In the positioning method, the synchronous marks formed at intervals corresponding to the track widths in the spiral servo pattern are not used during the positioning, so that a disturbance of the reproduction signal, that is, the noise can be suppressed to enhance the positioning accuracy of the electromagnetic conversion element.

Moreover, according to the embodiment, the electromagnetic conversion element positioning method that can contribute to the improvement of the positioning accuracy can be provided.

The whole or part of the processing operation implemented by the positioning program may be implemented based on dedicated hardware.

The various modules of the systems described herein can be implemented as software applications, hardware and/or software modules, or components on one or more computers, such as servers. While the various modules are illustrated separately, they may share some or all of the same underlying logic or code.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An electromagnetic conversion element positioning method comprising:
counting a servo clock for every servo sector radially extending on a recording medium, the servo clock being changed in synchronization with a change in rotation angle of the recording medium;
reading magnetic information from spiral servo patterns with an electromagnetic conversion element, the spiral servo patterns being arranged at equal intervals in a circumferential direction of the recording medium, the spiral servo patterns having magnetic materials arrayed along a spiral line maintaining a defined inclined angle with respect to a circumferential line over a predetermined radial region;
specifying a position of the spiral servo patterns on the circumferential line based on the read magnetic information;
correlating the count value of the servo clock with the specified position; and
specifying a radial position of the electromagnetic conversion element based on the correlated count value.

2. The electromagnetic conversion element positioning method of claim 1, further comprising:
specifying a decrease equal to or more than a defined value in counting the servo clock;
counting the number of times of the decrease equal to or more than the defined value every time the decrease equal to or more than the defined value is specified;
multiplying the number of times of the decrease by a maximum value of the count value of the servo clock; and
specifying the radial position of the electromagnetic conversion element based on the multiplication result.

3. The electromagnetic conversion element positioning method of claim 1, further comprising:
specifying an increase equal to or more than a defined value in counting the servo clock;
counting the number of times of the increase equal to or more than the defined value every time the increase equal to or more than the defined value is specified;
multiplying the number of times of the increase by a maximum value of the count value of the servo clock; and
specifying the radial position of the electromagnetic conversion element based on the multiplication result.

4. The electromagnetic conversion element positioning method of claim 1, wherein, in counting the servo clock, when a spiral servo pattern that is switched in a rotating direction of the recording medium from an adjacent spiral servo pattern is set, the count value of the servo clock is corrected by a count value corresponding to −1/n of the maximum count value according to the number of spiral servo patterns n allocated to one servo sector, and
when a spiral servo pattern that is switched in a direction opposite the rotating direction of the recording medium from an adjacent spiral servo pattern is set, the count value of the servo clock is corrected by a count value corresponding to 1/n of the maximum count value.

5. The electromagnetic conversion element positioning method of claim 1, further comprising adding a count value of the servo clock corresponding to one track pitch to a count value of the servo clock specifying a reference circular recording track for every circular recording track when a concentric circular recording track is written in the circumferential line.

6. The electromagnetic conversion element positioning method of claim 5, further comprising specifying a track number for every circular recording track based on the count value after the addition and the count value of the servo clock corresponding to one track pitch.

7. The electromagnetic conversion element positioning method of claim 1, further comprising:
counting the number of passages of the spiral servo pattern; and
specifying the sector number of the servo sector based on the number of passages and presence or absence of the switching of the spiral servo pattern.
